(19) United States
(12) Patent Application Publication
(10) Pub. No.: US 2020/0151004 A1
(43) Pub. Date: May 14, 2020

(54) REMOTE WORKING SYSTEM AND WORKING METHOD THEREOF

(71) Applicant: Institute For Information Industry, Taipei (TW)

(72) Inventors: Chao-Chin YANG, Taoyuan City (TW); Chih-Hsuan LIANG, New Taipei City (TW); Shih-Yu LU, Nantou County (TW); Hsin-Tse LU, Taipei City (TW)

(21) Appl. No.: 16/212,510

(22) Filed: Dec. 6, 2018

(30) Foreign Application Priority Data
Nov. 9, 2018 (TW) 107139871

(51) Int. Cl. G06F 9/48

(52) U.S. Cl. CPC G06F 9/4843; G06F 9/5077

(57) ABSTRACT

A remote working system and a working method thereof are provided. The remote working system includes at least one processor and stores a description file of a workflow. The description file includes a first task description and a second task description. The remote working system receives a service request of executing the workflow. The at least one processor determines a first identification code and a first operation address according to the first task description and calls a first operation program by using the first identification code and the first operation address. A first operation processor executes the first operation program, determines a second identification code and a second operation address according to the second task description, and calls a second operation program by using the second identification code and the second operation address. A second operation processor executes the second operation program.

### PRIORITY

This application claims priority to Taiwan Patent Application No. 107139871 filed on Nov. 9, 2018, which is hereby incorporated by reference in its entirety.

### FIELD

The present invention relates to a remote working system and a working method thereof. Specifically, the present invention relates to a decentralized remote working system and a working method thereof.

### BACKGROUND

Conventional remote (e.g., cloud, fog, fog-cloud cooperation) working system 1 adopts a centralized management architecture, that is, adopting a single control node 11 to control the workflow corresponding to a service request 10 (e.g., an event trigger) as shown in FIG. 1. Specifically, after receiving the service request 10, the control node 11 sequentially designates the operation nodes 13a, 13b, . . . , 13z to execute different work tasks of a workflow according to the service request 10 as well as transmits the data required during the operations to the operation nodes 13a, 13b, . . . , 13z. Some of the operation nodes require the operation result of the previous operation node in order to execute the work task, and these operation results have to be forwarded via the control node 11 (e.g., the operation node 13b requires the operation result of the operation node 13a in order to execute the work task, so the control node 11 has to receive the operation result of the operation node 13a and then transmits the operation result of the operation node 13a to the operation node 13b).

Because the remote working system 1 has to execute different workflows in response to different service requests and because the assignment and data transmission of every work task of all the workflows have to be performed by the single control node 11, cost and time regarding the operations and the data transmissions are extremely high and bottleneck of performance occur easily. Moreover, if the control node 11 breaks down, the workflows of all the service requests cannot be operated successfully.

If the remote working system 1 is a fog-cloud cooperation system (i.e., the control node 11 is a cloud apparatus, while the operation nodes 13a, 13b, . . . , 13z are fog apparatuses), the aforesaid drawbacks become more apparent. Specifically, in most scenarios, a fog apparatus cannot connect with the cloud apparatus all the time. However, if the fog apparatus fails to connect with the cloud apparatus, the work task cannot be executed. Moreover, some fog apparatuses require instant response, so the slow response from the cloud apparatus is intolerable. Furthermore, a fog apparatus usually generates huge amount of data, so there will be huge burden on both the cloud apparatus and the network resource if data of every fog apparatus has to be forwarded via the cloud apparatus.

After the rise of serverless computing, it is expected that more and more workflows executed by remote working systems will be developed because users do not need to worry about the deployment, setting, and management of servers. If a remote working system still adopts the centralized management architecture, the aforesaid various drawbacks will be aggravated. Accordingly, it is an urgent task to improve the cost and time of network transmission and improve the working efficiency and stability of a remote working system.

### SUMMARY

Provided is a remote working system. The remote working system may comprise a network interface, a storage, and at least one processor, wherein the at least one processor is electrically connected to the network interface and the processor. The network interface is configured to receive a service request of executing a workflow. The storage is configured to store a description file of the workflow, wherein the description file comprises a first task description and a second task description.

The at least one processor is configured to retrieve the description file from the storage in response to the service request, determine a first identification code and a first operation address according to the first task description, and call a first operation program by using the first identification code and the first operation address. A first operation processor corresponding to the first operation address executes the first operation program, determines a second identification code and a second operation address according to the second task description, and calls a second operation program by using the second identification code and the second operation address, wherein the first operation processor is one of the at least one processor. A second operation processor corresponding to the second operation address executes the second operation program, wherein the second operation processor is one of the at least one processor.

Also provided is a working method for a remote working system. The remote working system may comprise at least one processor and stores a description file of a workflow, wherein the description file comprises a first task description and a second task description. The working method may comprise the following steps (a)-(h).

The step (a) receives, by the remote working system, a service request of executing the workflow. The step (b) retrieves, by the at least one processor, the description file in response to the service request. The step (c) determines, by the at least one processor, a first identification code and a first operation address according to the first task description. The step (d) calls, by the at least one processor, a first operation program by using the first identification code and the first operation address. The step (e) executes, by a first operation processor corresponding to the first operation address, the first operation program, wherein the first operation processor is one of the at least one processor. The step (f) determines, by the first operation processor, a second identification code and a second operation address according to the second task description. The step (g) calls, by the first operation processor, a second operation program by using the second identification code and the second operation address. The step (h) executes, by a second operation processor corresponding to the second operation address, the second operation program, wherein the second operation processor is one of the at least one processor.

The provided remote working technology (including the remote working system and the working method thereof) use a decentralized architecture to execute different work tasks of a workflow. Each operation processor executes a work task and then triggers the next operation processor to execute the next work task and thereby accomplish the operations of the workflow.

Generally speaking, the provided remote working technology finds out a description file of the workflow in response to a service request of executing the workflow, finds out a first identification code and a first operation address of a first work task according to a first task description related to a first work task in the description file, and calls the first operation program for accomplishing the first work task according to the first identification code and the first operation address. A first operation processor corresponding to the first operation address will execute the first operation program to accomplish the first work task. After executing the first operation program, the first operation processor finds out a second identification code and a second operation address related to a second work task (i.e., the next work task) in the description file and calls the second operation program for accomplishing the second work task according to the second identification code and the second operation address. A second operation processor corresponding to the second operation address will execute the second operation program.

After executing the second operation program, the second operation processor determines whether there is a next work task that needs to be executed according to the description file. If there is still a next work task that needs to be executed, the second operation processor adopts similar approach to call another operation program for accomplishing the next work task so that another operation processor executes the another operation program. Through the aforesaid decentralized architecture, the remote working technology provided by the present invention can effectively reduce the cost and time of network transmissions, can improve the efficiency and stability of the operations of the workflow, and will not fail all the workflows simply because a single control node breaks down.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view depicting a conventional remote working system 1 controlling a workflow via a single control node 11;

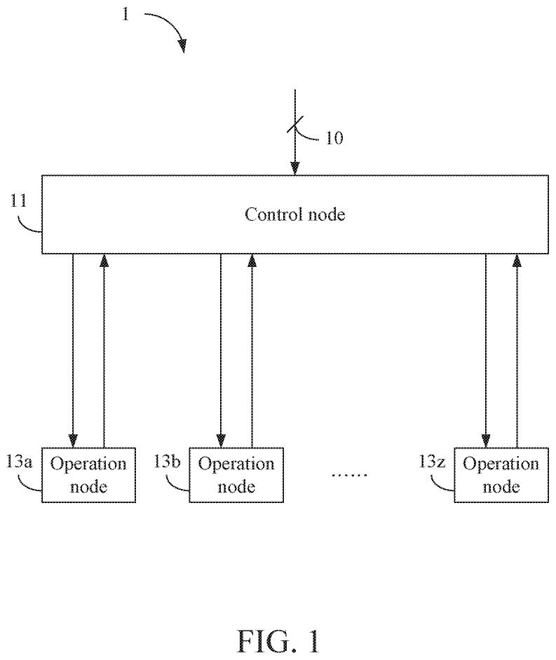

FIG. 2A is a schematic view of a remote working system 2 according to a first embodiment of the present invention;

FIG. 2B is a schematic view depicting the workflow WF provided by the remote working system of the present invention;

FIG. 3 is a schematic view of a remote working system 3 according to a second embodiment of the present invention; and

FIG. 4 is a flowchart depicting a working method according to a third embodiment of the present invention.

### DETAILED DESCRIPTION

In the following description, a remote working system and a working method thereof will be explained with reference to certain example embodiments thereof. However, these example embodiments are not intended to limit the present invention to any specific examples, embodiments, environments, applications, or implementations described in these example embodiments. Therefore, description of these example embodiments is only for purpose of illustration rather than to limit the present invention.

It shall be appreciated that, in the following embodiments and the attached drawings, elements unrelated to the present invention are omitted from depiction; and dimensions of elements and dimensional proportions among individual elements in the attached drawings are provided only for understanding, but not to limit the scope of the present invention.

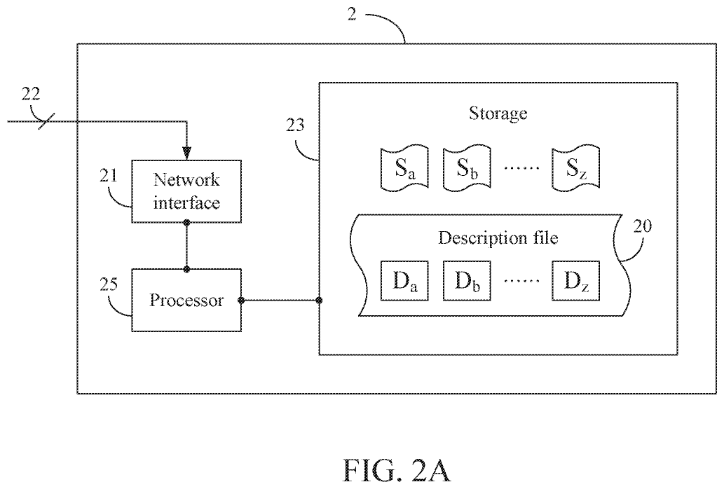

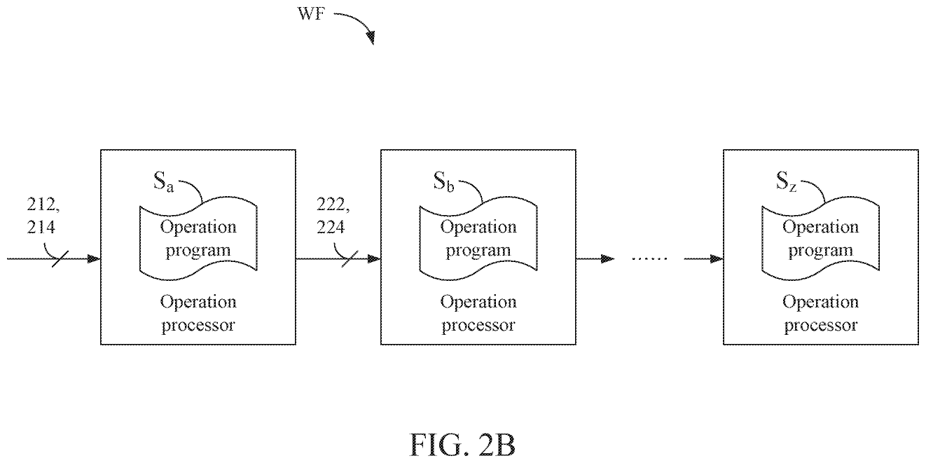

A first embodiment of the present invention is a remote working system 2, whose schematic view is depicted in FIG. 2A. The remote working system 2 comprises a network interface 21, a storage 23, and a processor 25 which is electrically connected to the network interface 21 and the storage 23. The network interface 21 may be a wired network interface or a wireless network interface that is configured to connect to a network (e.g., an Internet, a local area network, a telecommunication network, or any combination thereof) and receive and transmit signal and data via the network. The storage 23 may be a memory, a universal serial bus (USB), a hard disk, a compact disk (CD), a mobile disk, or any other non-transitory storage media or storage circuits that is capable of storing digital data and well-known to those of ordinary skill in the art. The processor 25 may be one of various processors, central processing units (CPU), microprocessor units (MPU), digital signal processors (DSP), or any other computing apparatuses well-known to those of ordinary skill in the art. The remote working system 2 may be a cloud apparatus (e.g., a cloud server), a fog apparatus (e.g., an industrial controller, a switch, an embedded server, and a router), or any other computing apparatuses that is capable of networking, computing, and storing and well-known to those of ordinary skill in the art.

The remote working system 2 provides a workflow WF as shown in FIG. 2B. The workflow WF comprises a plurality of operation programs Sₐ, S_{b}, . . . , S_{z} that have to be executed in sequence, wherein each of the operation programs Sₐ, S_{b}, . . . , S_{z} may be regarded as one work task of the workflow WF. The storage 23 stores the operation programs Sₐ, S_{b}, . . . , S_{z}. Moreover, the storage 23 stores a description file 20 of the workflow WF, wherein the description file 20 comprises a plurality of task descriptions Dₐ, D_{b}, . . . , D_{z} corresponding to the work tasks one-to-one. Each of the task descriptions Dₐ, D_{b}, . . . , D_{z} comprises an identification code and an operation address of the corresponding work task, wherein each of the operation addresses may be a uniform resource locator (URL) or any of other representations that can be used to locate a resource. Because the work tasks of the workflow WF have to be executed in sequence, the task descriptions Dₐ, D_{b}, . . . , D_{z} are arranged in sequence.

It shall be appreciated that the present invention does not limit the number of the operation programs Sₐ, S_{b}, . . . , S_{z} comprised in the workflow WF to any specific number as long as the number is plural. In other words, the present invention dos not limit the number of the task descriptions Dₐ, D_{b}, . . . , D_{z} comprised in the description file 20 to any specific number as long as the number is plural. Moreover, the number of workflows that can be provided by the remote working system 2 is not limited in the present invention.

In this embodiment, the network interface 21 receives a service request 22 of executing the workflow WF. For example, the service request 22 may be an event trigger (e.g., a value sensed by a sensor is larger than a threshold). After the network interface 21 receives the service request 22, the remote working system 2 provides the workflow WF accordingly.

Specifically, the processor 25 retrieves the description file 20 from the storage 23 in response to the service request 22. Because the task descriptions Dₐ, D_{b}, . . . , D_{z} are arranged in the description file 20 in sequence, the processor 25 knows that the first to be read is the task description Dₐ. The processor 25 determines the recorded identification code 212 and operation address 214 according to the task description Dₐ and then calls the operation program Sₐ (i.e., the first work task in the workflow WF) by using the identification code 212 and operation address 214.

Next, the operation processor corresponding to the operation address 214 (which is the processor 25 in this embodiment) identifies the operation program Sₐ according to the identification code 212 and then executes the operation program Sₐ. The operation processor corresponding to the operation address 214 knows that the next task description to be read is the task description D_{b}, so the operation processor determines the recorded identification code 222 and operation address 224 according to the task description D_{b} and then calls the operation program S_{b} (i.e., the next work task) by using the identification code 222 and operation address 224.

Next, the operation processor corresponding to the operation address 224 (which is the processor 25 in this embodiment) identifies the operation program S_{b} according to the identification code 222 and then executes the operation program S_{b}. Similarly, the operation processor corresponding to the operation address 224 knows that the next task description to be read is the task description D_{c}, so the operation processor determines the recorded identification code and operation address according to the task description D_{c} and then calls the operation program S_{c} (i.e., the next work task) by using the identification code and the operation address recorded by the task description D_{c}.

The remote working system 2 continues to operate according to the aforesaid principle. That is, the current operation processor reads the next task description, calls the next operation program according to the identification code and the operation address recoded in the task description, and repeats the aforesaid operations until all the operation programs Sₐ, S_{b}, . . . , S_{z} comprised in the workflow WF have been executed.

In some embodiments, the parameters required by the aforesaid operation processors for executing the operation programs are recorded in the corresponding task descriptions. In these embodiments, each of the operation processors further retrieve the required parameter(s) from the corresponding task description. Specifically, the operation processor corresponding to the operation address 214 retrieves at least one first parameter (not shown) from the task description Dₐ according to the identification code 212 before executing of the operation program Sₐ and then executes the operation program Sₐ according to the at least one first parameter after retrieving the at least one first parameter. Similarly, the operation processor corresponding to the operation address 224 retrieves at least one second parameter (not shown) from the task description D_{b} according to the identification code 222 before executing the operation program S_{b} and then executes the operation program S_{b} according to the at least one second parameter after retrieving the at least one second parameter. Other operation processors will also retrieve the required parameters from the corresponding task description before executing the corresponding operation program and will then execute the corresponding operation program according to the retrieved parameters. The details will not be repeated herein.

In some embodiments, each of the aforesaid operation processors will generate an operation result after the execution of the operation program, and each of the operation results will be integrated into the description file 20 to be used by the next operation processor during the execution of the operation program. Specifically, the operation processor corresponding to the operation address 214 generates a first operation result (not shown) after the execution of the operation program Sₐ, integrates the first operation result into the description file 20, and provides the description file 20 to the operation program S_{b} when calling the operation program S_{b}. Similarly, the operation processor corresponding to the operation address 224 generates a second operation result (not shown) after the execution of the operation program S_{b}, integrates the second operation result into the description file 20, and provides the description file 20 to the operation program S_{c} when calling the operation program S_{c}. Other operation processors will also integrate the operation results into the description file 20 after the execution of other operation programs and provide the description file 20 when calling the next operation program so that the operation results can be used by the next operation processor during the execution of the next operation program. The details will not be repeated herein.

In some embodiments, the remote working system 2 may adopt the container technology to accomplish every work task of the workflow WF, i.e., packing all information required for executing the operation program into a container and having the container to execute the operation program. Specifically, the operation processor corresponding to the operation address 214 generates a first container, executes the operation program Sₐ via the first container, and deletes the first container after executing the operation program Sₐ and calling the operation program S_{b}. Similarly, the operation processor corresponding to the operation address 224 generates a second container, executes the operation program S_{b} via the second container, and deletes the second container after executing the operation program S_{b} and calling the operation program S_{c}. Each of the rest operation processor will also generate a container, execute the corresponding operation program via the container, and delete the container after executing the operation program and calling the next operation program and, thus, the detail will not be repeated herein. The details regarding how each of the operation processors generates the container and uses the container to execute an operation program shall be well known by those of ordinary skill in the art, and, thus, will not be described herein.

In some embodiments, each of the aforesaid operation processors may be a virtual machine of the remote working system 25. The details regarding how to set the virtual machine and how to use the virtual machine as the aforesaid operation processor shall be well-known by those of ordinary skill in the art, and, thus, the details will not be described herein.

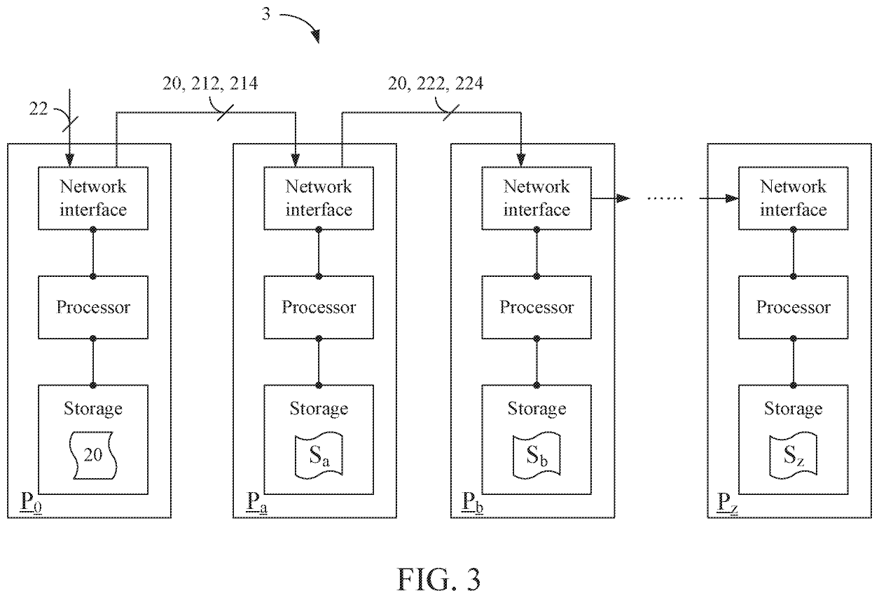

A second embodiment of the present invention is a remote working system 3, whose schematic view is depicted in FIG. 3. The main difference between the remote working system 3 of the second embodiment and the remote working system 2 of the first embodiment lies in the hardware architecture of the systems. Despite the hardware architecture of the two systems being different, the principle of executing the workflow WF is the same (i.e., the remote working system 3 also provides the workflow WF shown in FIG. 2B). Hereinafter, only the difference between the second embodiment and the first embodiment will be described in detail.

The remote working system 3 comprises a plurality of remote apparatuses P₀, Pₐ, P_{b}, . . . , P_{z}. Each of the remote apparatuses P₀, Pₐ, P_{b}, . . . , P_{z} may be a cloud apparatus (e.g., a cloud server), a fog apparatus (e.g., an industrial controller, a switch, an embedded server, and a router) or any other computing apparatus capable of networking, computing, and storing and well-known to those of ordinary skill in the art. Each of the remote apparatuses P₀, Pₐ, P_{b}, . . . , P_{z} comprises a network interface, a storage, and a processor, and the processor is electrically connected to the network interface and the storage. In this embodiment, the description file 20 is stored in the storage of the remote apparatus P₀, and the operation programs Sₐ, S_{b}, . . . , S_{z} are respectively stored in the storages of the remote apparatuses P₀, Pₐ, P_{b}, . . . , P_{z}.

In this embodiment, the network interface of the remote apparatus P₀ receives the service request 22 of executing the workflow WF. The processor of the remote apparatus P₀ retrieves the description file 20 from the storage in response to the service request 22, determines the recorded identification code 212 and operation address 214 according to the task description Dₐ, and then uses the identification code 212 and operation address 214 to call the operation program Sₐ (i.e., the first work task in the workflow WF). While calling the operation program Sₐ, the remote apparatus P₀ also provides the description file 20.

Next, the operation processor corresponding to the operation address 214 (which is the processor of the remote apparatus Pₐ in this embodiment) loads the operation program Sₐ from its storage and then executes the operation program Sₐ. Next, the processor of the remote apparatus Pₐ determines the recorded identification code 222 and operation address 224 according to the task description D_{b} (i.e., the next task description), and then calls the operation program S_{b} (i.e., the next work task) by using the identification code 222 and operation address 224. While calling the operation program S_{b}, the remote apparatus Pₐ also provides the description file 20. Next, the operation processor corresponding to the operation address 224 (which is the processor of the remote apparatus P_{b} in this embodiment) loads the operation program S_{b} from its storage and then executes the operation program S_{b}.

The remote working system 3 continues to operate according to the aforesaid principle. That is, the current operation processor reads the next task description and calls the next operation program according to the identification code and the operation address recoded in the task description, and repeats the aforesaid operations until all the operation programs Sₐ, S_{b}, . . . , S_{z} indicated in the workflow WF have been executed. Please note that the calling of and the signal/data transmissions between the remote apparatuses Pₐ, P_{b}, . . . , P_{z} are achieved via the network interface comprised in the remote apparatuses, which shall be appreciated by those of ordinary skill in the art and, thus, the details will not be further described herein.

In addition to the aforesaid operations, the remote working system 3 can also execute all the operations of the remote working system 2, have the same functions, and deliver the same technical effects as the remote working system 2. How the remote working system 3 executes these operations, has the same functions, and delivers the same technical effects as the remote working system 2 will be readily appreciated by those of ordinary skill in the art based on the explanation of the remote working system 2, and, thus, the details will not be further described herein.

According to the description of the aforesaid embodiments, those of ordinary skill in the art shall appreciate that the remote working system provided by the present invention may also have other embodiments. The present invention does not require that all the operation programs have to be executed by the same processor (e.g., the remote working system 2 in the first embodiment). Also, the present invention does not require that each processor executes only one operation program (e.g., the remote working system 3 in the second embodiment). In other words, in some embodiments of the present invention, some processors in the remote working system execute one operation program, while some processors execute a plurality of operation programs. The details will not be further described herein.

According to the above descriptions, the remote working systems 2 and 3 adopt a decentralized architecture to execute different work tasks (i.e., operation programs Sₐ, S_{b}, . . . , S_{z}) of the workflow WF. Every operation processor triggers the next operation processor to execute the next work task (i.e., the next operation program is directly called) until all the work tasks of the workflow WF have been finished. Because the remote working systems 2 and 3 adopt the aforesaid decentralized architecture, no control node is required to be responsible for assignment and data transmission of the work tasks of the workflow WF. In this way, the remote working systems 2 and 3 can effectively reduce the cost and time of network transmissions, improve the efficiency and stability of the operations of the workflow WF, and will not fail all the workflows simply because a single control node breaks down.

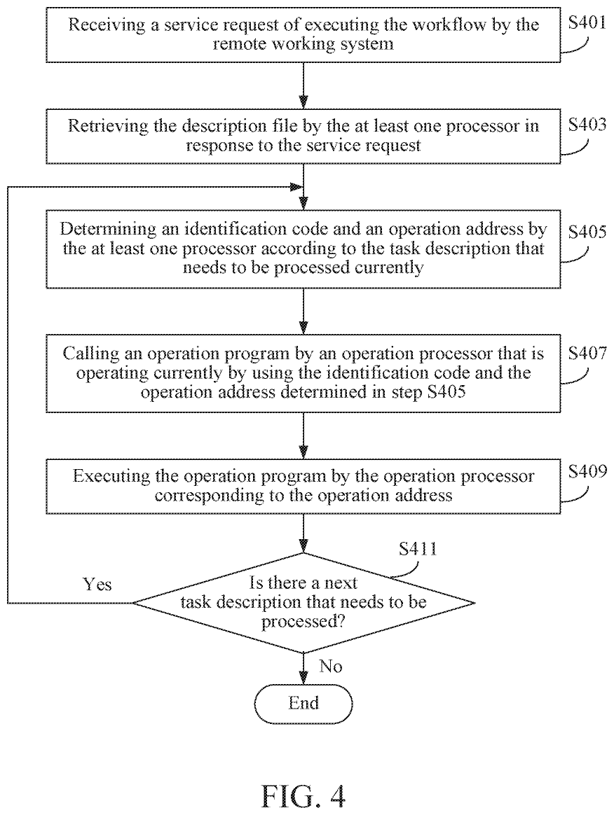

A third embodiment of the present invention is a working method for use in a remote working system (e.g., the aforesaid working systems 2 and 3 of the aforesaid embodiments), whose flowchart is depicted in FIG. 4. The remote working system comprises at least one processor. The remote working system stores a description file (e.g., the description file 20 of FIG. 2A) of a workflow (e.g., the workflow WF of FIG. 2B). The workflow comprises a plurality of operation programs that need to be executed in sequence, wherein each of the operation programs may be regarded as one work task of the workflow. The description file comprises a plurality of task descriptions corresponding to the work tasks one-to-one. Each of the task descriptions comprises an identification code and an operation address of the corresponding work task. The work tasks of the workflow have to be executed in sequence, so the task descriptions are arranged in the description file in sequence. The working method comprises the following steps S401 to S411.

First, in step S401, the remote working system receives a service request of executing the workflow. The service request triggers the remote working system to execute the workflow. In step S403, the at least one processor retrieves the description file in response to the service request. Next, in step S405, the at least one processor determines an identification code and an operation address according to the task description that needs to be processed currently. In step S407, an operation processor that is operating currently calls an operation program by using the identification code and the operation address determined in step S405. In step S409, the operation processor corresponding to the operation address executes the operation program.

In step S411, the operation processor corresponding to the operation address determines whether there is a next task description that needs to be processed. If the step S411 finds out that there is no other task description that needs to be processed, it means that the operation program executed by the previous step is the last operation program of the workflow and, hence, the workflow can be ended. If the step S411 finds out that there are other task descriptions that need to be processed, the steps S405 to S409 are executed again to process the next task description and then the step S411 is executed.

As described previously, the remote working system comprises at least one processor. The operation processor described in the steps S407 and S409 is one of the at least one processor. In some embodiments, the working method executes the step S409 for many times, and the operation processor executing the step S409 for each time is a different processor. In some embodiments, the working method executes the step S409 for many times, and the operation processor executing the step S409 for each time is the same processor.

In some embodiments, the working method further retrieves at least one parameter from the task description that is to be processed currently when executing the step S405. The working method further transmits the at least one parameter when executing the step S407. The step S409 of the working method executes the operation program by the operation processor corresponding to the operation address according to the at least one parameter.

In some embodiments, the step S409 further generates an operation result. The working method further comprises a step to integrate the operation result into the description file by the operation processor corresponding to the operation address. In these embodiments, if the determination result in the subsequent step S411 is yes, the steps S405 to S409 will be executed again to process the next task description, and the description file (comprising the operation result) will be provided when executing the step S407 for calling the next operation program.

In some embodiments, the working method may adopt the container technology to accomplish the work tasks of the workflow. Specifically, before the execution of the step S409, the working method further generates a container by the operation processor corresponding to the operation address. In the step S409, the operation processor corresponding to the operation address executes the operation program via the container. After the working method has executed the step S409 and called the next operation program (if any), the container may be deleted.

In some embodiments, the working method executes the step S409 for many times, and the operation processor executing the step S409 for each time is a virtual machine.

In addition to the aforesaid steps, the third embodiment can also execute all the operations and steps of the remote working systems 2, 3 set forth in the first and second embodiments, have the same functions, and deliver the same technical effects as the first and second embodiments. How the third embodiment executes these operations and steps, has the same functions, and delivers the same technical effects as the first and second embodiments will be readily appreciated by those of ordinary skill in the art based on the explanation of the first and second embodiments. Thus, the details will not be repeated herein.

It shall be appreciated that, in the specification and the claims of the present invention, some terms (including operation processor, task description, identification code, operation address, parameter, and operation result) are preceded by the terms “first” or “second,” and these terms of “first” and “second” are used only for distinguishing different stages of the remote workflow.

According to the above descriptions, the remote working technology (at least including the remote working system and the working method thereof) provided by the present invention uses a decentralized architecture to execute different work tasks of a workflow after receiving a service request of executing the workflow. After an operation processor has executed a work task, the next operation processor is triggered to execute the next work task, thereby accomplishing the operation of the workflow. With the decentralized operation architecture, the remote working technology provided by the present invention does require a single control node to assign all the work tasks and transmission data of the workflow, so the remote working technology can effectively reduce the cost and time of network transmissions, and can improve the efficiency and stability of the operations of the workflow, and will not fail all the workflows simply because a single control node breaks down.

The above disclosure is only utilized to enumerate partial embodiments of the present invention and illustrated technical features thereof, but not to limit the scope of the present invention. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A remote working system, comprising:
a network interface, being configured to receive a service request of executing a workflow;
a storage, being configured to store a description file of the workflow, wherein the description file comprises a first task description and a second task description; and
at least one processor electrically connected to the network interface and the storage, being configured to retrieve the description file from the storage in response to the service request, determine a first identification code and a first operation address according to the first task description, and call a first operation program by using the first identification code and the first operation address,
wherein a first operation processor corresponding to the first operation address executes the first operation program, determines a second identification code and a second operation address according to the second task description, and calls a second operation program by using the second identification code and the second operation address, wherein the first operation processor is one of the at least one processor, and
wherein a second operation processor corresponding to the second operation address executes the second operation program, and the second operation processor is one of the at least one processor.

2. The remote working system of claim 1, wherein the first operation processor further retrieves at least one first parameter from the first task description, the execution of the first operation program by the first operation processor is further based on the at least one first parameter, the second operation processor further retrieves at least one second parameter from the second task description, and the execution of the second operation program by the second operation processor is further based on the at least one second parameter.

3. The remote working system of claim 1, wherein the execution of the first operation program by the first operation processor further generates an operation result, the first operation processor further integrates the operation result into the description file, and the first operation processor further provides the description file to the second operation program when calling the second operation program.

4. The remote working system of claim 1, wherein the first operation processor and the second operation processor are a same processor.

5. The remote working system of claim 1, wherein the first operation processor and the second operation processor are different processors.

6. The remote working system of claim 1, wherein the first operation processor further generates a first container, the execution of the first operation program by the first operation processor is accomplished via the first container, the second operation processor further generates a second container, and the execution of the second operation program by the second operation processor is accomplished via the second container.

7. The remote working system of claim 1, wherein each of the first operation processor and the second operation processor is a virtual machine.

8. A working method for a remote working system, the remote working system comprising at least one processor and storing a description file of a workflow, the description file comprising a first task description and a second task description, the working method comprising:
(a) receiving, by the remote working system, a service request of executing the workflow;
(b) retrieving, by the at least one processor, the description file in response to the service request;
(c) determining, by the at least one processor, a first identification code and a first operation address according to the first task description;
(d) calling, by the at least one processor, a first operation program by using the first identification code and the first operation address;
(e) executing, by a first operation processor corresponding to the first operation address, the first operation program, wherein the first operation processor is one of the at least one processor;
(f) determining, by the first operation processor, a second identification code and a second operation address according to the second task description;
(g) calling, by the first operation processor, a second operation program by using the second identification code and the second operation address; and
(h) executing, by a second operation processor corresponding to the second operation address, the second operation program, wherein the second operation processor is one of the at least one processor.

9. The working method of claim 8, further comprising:
retrieving, by the first operation processor, at least one first parameter from the first task description, wherein the execution of the first operation program by the first operation processor is further based on the at least one first parameter; and
retrieving, by the second operation processor, at least one second parameter from the second task description, wherein the execution of the second operation program by the second operation processor is further based on the at least one second parameter.

10. The working method of claim 8, wherein the step (e) further generates an operation result, and the working method further comprises:
integrating, by the first operation processor, the operation result into the description file,
wherein the step (g) further provides the description file to the second operation program.

11. The working method of claim 8, wherein the first operation processor and the second operation processor are a same processor.

12. The working method of claim 8, wherein the first operation processor and the second operation processor are different processors.

13. The working method of claim 8, further comprising:
generating, by the first operation processor, a first container, wherein the execution of the first operation program by the first operation processor is accomplished via the first container; and
generating, by the second operation processor, a second container, wherein the execution of the second operation program by the second operation processor is accomplished via the second container.

14. The working method of claim 8, wherein each of the first operation processor and the second operation processor is a virtual machine.
